(19) United States
(12) Patent Application Publication
(10) Pub. No.: US 2004/0075289 A1
(43) Pub. Date: Apr. 22, 2004

(54) Hydraulic operated piling grabber

(76) Inventor: Louis Edwin King, Metairie, LA (US)

Correspondence Address: LOUIS E. KING, 7005 KAWANEE AVE, METAIRIE, LA, 70003, US

(21) Appl. No.: 10/274,775

(22) Filed: Oct. 19, 2002

(51) Int. Cl. B25J 15/00

(52) U.S. Cl. 294/88; 294/104

(57) ABSTRACT

A versatile piece of hydraulically operated equipment for the use of handling and placement of wooden pilings for construction of foundation slabs in rear yards. With minimum access for house additions, able to grab, lift, and carry for placement of pilings for house additions, camps, bulkheads, or any foundation construction. Able to grab, lift, handle, and maneuver pilings of twenty, thirty, or forty feet in length, around trees, houses, under power lines or other obstacles to reach the desired position in any environment to place and shove pilings into specific pre-drilled holes, and drive pilings to desired elevations for construction site. An innovation in the placement of pilings in normally inaccessable areas which cannot be accomplished by present equipment available.

### BACKGROUND OF THE INVENTION

1. Field of the Invention

The present invention relates to an improved way for the handling and driving of pilings for Slabs, Camps, Piers, Etc. . . . more particulary, the present invention relates to the lifting, handling, and driving of wooden pilings with a length of 30′ or more, to place and insert into 8′ Pre-drilled holes and then squeezed and shoved down into the ground to a specific grade for Concrete House Slabs, Commercial building Slabs, above ground Camps, Piers, Utility Poles etc.

2. General Background

Pilings have been used for a long time to support foundations such as Slabs, and to prevent these foundations from sinking due to soft subsiding ground. Pilings have generally been driven with the use of large cranes which can cause damage to existing homes, they need large access, plenty of clearence from overhead power lines, and do not have the access to Back-Yards for Additions to existing homes.

### 3. SUMMARY OF THE INVENTION

The Present Invention (Hydraulic Operated Piling Grabber) solves the problems in the art in a simple and straight forward manner. What is provided with this Invention is an easy, safe, and cost effective manner in which to grab, handle, and drive pilings with a length of 30′ or more which can be driven in areas with a minimum 7′ width entrance, such as Back-Yards to houses.

This Invention can handle the weight of pilings in excess of 1,000 to 2,000 Pounds, it can grab, lift, tilt, raise, and carry the Piling to the Pre-Drilled hole, dropped in, and squeezed and shoved down to refusal. It provides the ability to drive Pilings quickly and efficiantly. It can be used to drive Pilings for Residential and Commercial Slabs, Foundations, as well as above water Camps fishing piers, etc . . . .

### DETAILED DESCRIPTION OF THE PREFFERED EMBODIMENT

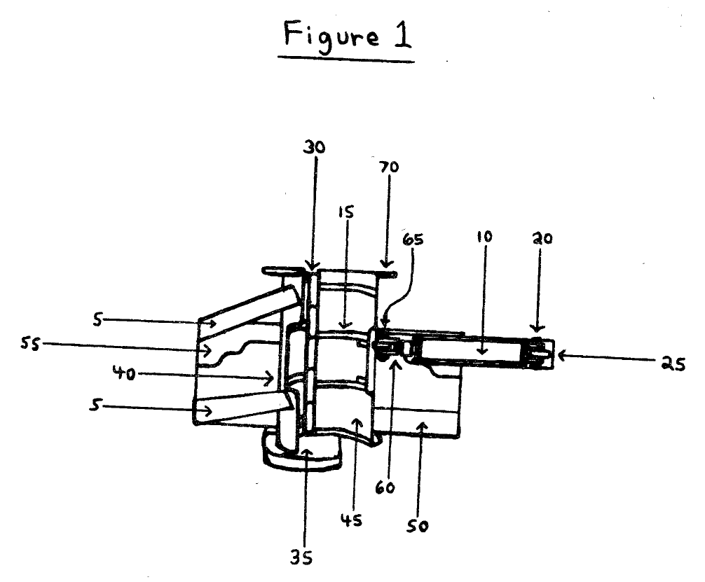

FIGS. 1 through 3 illustrate the preffered embodiment of the present invention.

As illustrated, the Hydraulic Operated Piling Grabber, which incorporates the unique Left jaw half closing mechanism (45) which is illustrated in FIG. 1. When the Cylinder (10) is hydraulically operating it will close Left Jaw Half (45) against Welded Right Jaw Half (40) which will Excert Pressure on the Piling being gripped. The inside wall of the Left and Right jaw halves are lined with hardened steel grips (15) to bite into the Piling for a very firm grip. The Welded Right Jaw Half (40) is supported by two angled plates (80) Top and Bottom, and also two Welded supports (5) Top and Bottom. The Cylinder Rod (75) of the Hydraulic Cylinder (10) is attached to the Left Jaw Half (45) by a bolt W/Lock Nut (65) to Welded Piece (25) by means of the Cylinder Mounting Bracket (60). The entire mechanism is Welded to the Bottom Frame Plate (50) and the Top Frame Plate (55) and also the Frame Right Side Plate (125) Which is Identical to the Frame Left Side Plate. The Pusher Plate (35) is Welded to

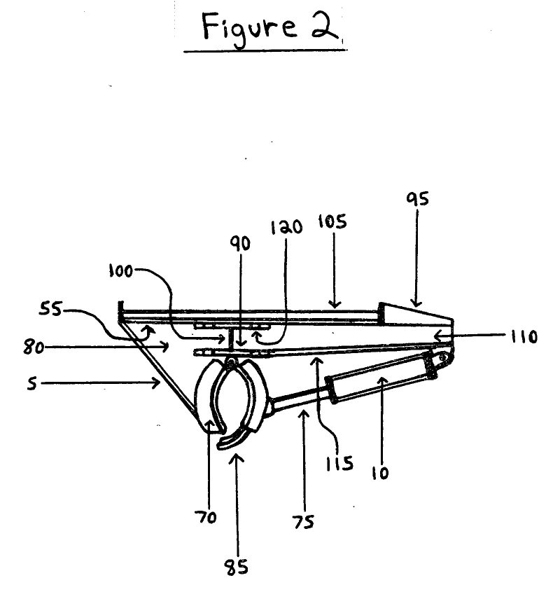

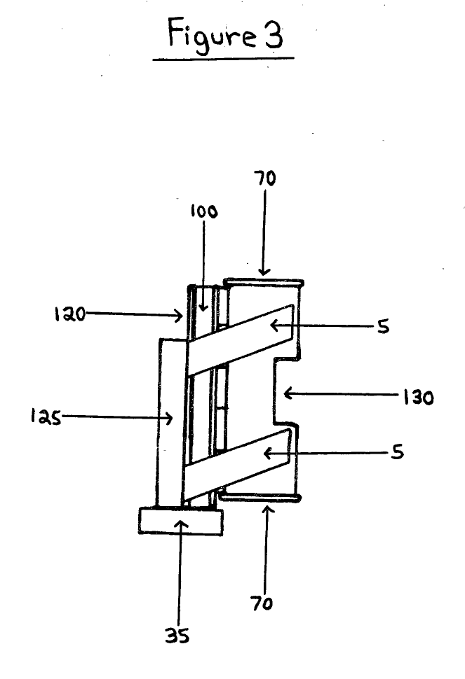

the Front Flat Plate (90) and Rear Flat Plate (120) and Welded Center Beam (100). FIG. 2 Shows and Above View of the Hydraulic Operated Piling Grabber in about a ¾ of the way Closed Position. FIG. 3 shows a Right Side View of the Invention. Center Beam (100) is Welded between the Rear Flat Plate (120) and Front Flat Plate (90) to give the correct spacing between the Jaws and the Frame. The First, Third,

### DETAILED DESCRIPTION OF (FIGS. 1-3)

5. Welded supports (Top and Bottom) for Right Welded Jaw Half

10. Cylinder for Operating Left Hinged Jaw Half

15. Hardened Steel Grips (Curved to Conform to inside of Left and Right Jaw Halves

20. Bolt to Connect Cylinder to Welded Piece (25) on Frame

25. Welded Piece to which the Cylinder attaches by means of a Bolt w/Lock nut

30. Hinges for Left Jaw Half to Pivet—Top, Center, and Bottom Hinge are Welded to Front Flat Plate (FIG. 2) (90) on Frame

35. Pusher Plate Welded to Bottom of Frame

40. Right Jaw Half (Welded to Frame)

45. Left Jaw Half-Hinged—Welded to Second and Fourth Hinge

50. Bottom Front Frame Plate

55. Top Front Frame Plate

60. Cylinder Mounting Bracket (Mounts to Welded Piece on Left Jaw Half (45) by means of a Bolt w/Lock nut

65. Bolt to connect Cylinder to Left Piveting Jaw Half (45)

70. Supports Welded to Top and Bottom outside of Left and Right Jaw Halves

75. Cylinder Rod

80. Angled Plate (Top and Bottom)

85. Extended Left Jaw Piece (Welded)

90. Front Flat Plate

95. Welded Rear Support

100. Welded Center Beam

105. Welded Short Top Plate

110. Center Plate Welded between Long Flat Front Plate (115) and Frame Top Plate (55)

115. Long Flat Front Plate

120. Rear Flat Plate

125. Frame Right Side Plate

130. Indention in Right Welded Jaw Half (Used to allow Extended Left Jaw Piece (85) to close up into giving a Better Shielded Grab on the Piling

### Parts List

5. Welded supports (Top and Bottom) for Right Welded Jaw Half

10. Cylinder for Operating Left Hinged Jaw Half

15. Hardened Steel Grips (Curved to Conform to inside of Left and Right Jaw Halves

20. Bolt to Connect Cylinder to Welded Piece (25) on Frame

25. Welded Piece to which the Cylinder attaches by means of a Bolt w/Lock nut

30. Hinges for Left Jaw Half to Pivet—Top, Center, and Bottom Hinge are Welded to Front Flat Plate (FIG. 2) (90) on Frame

35. Pusher Plate Welded to Bottom of Frame

40. Right Jaw Half (Welded to Frame)

45. Left Jaw Half-Hinged—Welded to Second and Fourth Hinge

50. Bottom Front Frame Plate

55. Top Front Frame Plate

60. Cylinder Mounting Bracket (Mounts to Welded Piece on Left Jaw Half (45) by means of a Bolt w/Lock nut

65. Bolt to connect Cylinder to Left Piveting Jaw Half (45)

70. Supports Welded to Top and Bottom outside of Left and Right Jaw Halves

75. Cylinder Rod

80. Angled Plate (Top and Bottom)

85. Extended Left Jaw Piece (Welded)

90. Front Flat Plate

95. Welded Rear Support

100. Welded Center Beam

105. Welded Short Top Plate

110. Center Plate Welded between Long Flat Front Plate (115) and Frame Top Plate (55)

115. Long Flat Front Plate

120. Rear Flat Plate

125. Frame Right Side Plate

130. Indention in Right Welded Jaw Half (Used to allow Extended Left Jaw Piece (85) to close up into giving a Better Shielded Grab on the Piling and Fifth Hinges (30) are Welded to the Front Flat-Plate (90) and Welded Right Jaw Half (40). The Second, and Fourth Hinges are Welded to the Left Piveting Jaw Half (45).

1. A Hydraulic Piling Grabber for Driving Pilings.
A. Able to Grab, Lift, Tilt, Raise, Carry, and Drive Pilings.
B. Able to Firmly Grip Pilings due to the Hardened Steel Grips Lining the Inner Walls of the Left and Right Jaw Halves.
C. Can be used in areas with a minimum Width Access of 7′ to carry and Drive 30′ or more wooden Pilings.
D. Can Drive Pilings on angles to shore up existing sinking house slabs.
